(19) United States
(12) Patent Application Publication
(10) Pub. No.: US 2002/0169610 A1
(43) Pub. Date: Nov. 14, 2002

(54) Method and system for automatically converting text messages into voice messages

(76) Inventor: Volker Luegger, Froendenberg (DE)

Correspondence Address: Bell, Boyd & Lloyd LLC, P.O. Box 1135, Chicago, IL, 60690, US

(21) Appl. No.: 10/117,291

(22) Filed: Apr. 5, 2002

(30) Foreign Application Priority Data
Apr. 6, 2001 (DE) 101 17 367.9

(51) Int. Cl. G10L 13/08

(52) U.S. Cl. 704/260

(57) ABSTRACT

A method and a system which acoustically outputs any written machine-readable text messages, such as e-mails or fax messages, on the basis of a previously generated voice profile via a suitable acoustic reproduction system; for example, via a mobile phone. For the automatic conversion of text messages into voice messages, voice sample data of a user are analyzed and a voice profile is created on the basis of this analysis. The voice output which is possible as a result, with a voice which is natural and, in particular, familiar, avoids alienation when listening to the output voice.

### BACKGROUND OF THE INVENTION

The present invention relates to a method and a system which acoustically outputs any written machine-readable text messages, such as e-mails or fax messages, on the basis of a previously generated voice profile via a suitable acoustic reproduction system; for example, via a mobile phone.

According to the prior art, it is known to output in a multimedia environment contents of e-mails, fax messages or other texts via unalterably predetermined synthetically generated voices. To make communication in a multimedia environment (in the literature, reference is often made in this context to a “Unified Message System”) seem as natural as possible, it is of interest to output the corresponding text message with the voice of the respective author.

DE 198 41 683 A1 discloses a device and a method for digital voice processing. The words which can be converted into a voice output are recorded in a table (dictionary) together with information on their pronunciation (phonetic entries, phonetic equivalents). A translator generates from the phonetic entries of the individual words a voice message file, which can be displayed and processed in an editor (editing device) in the form of a phonetic transcription. For processing, parameters (modifiers) are added or changed. The parameters of various types of speaker (man, woman, child, etc.) are grouped together in a respective voice profile (speaker model) and prescribed as standard models. By adapting the parameters, the user forms (edits) the “voice” of the subsequent synthetic voice output to the desired qualitative state.

In the known method, it has proven to be disadvantageous that the generated voice output, made to resemble natural voices, usually still sounds artificial or strange and is unfamiliar to the listener.

The present invention is, therefore, directed toward achieving a voice reproduction of machine-readable texts with synthetically generated voices in such a way as to avoid alienation when listening to the generated voice.

### SUMMARY OF THE INVENTION

Thus, according to the present invention, it is proposed that, for the automatic conversion of text messages into voice messages of a user, voice sample data of the user are analyzed and a voice profile is created on the basis of this analysis. On the basis of the voice profile created, any text message data can be output with the voice of the user in an approximated, or easily recognizable, manner. In particular, identification of the sender from the voice is possible if the text messages are correspondingly assigned to the voices.

The creation of the voice profile may in this case be performed, for example, by a comparison of a written reference text with a reference text generated by acoustic articulation of a speaker.

According to the present invention, a system for converting text messages into voice messages is also claimed. This system has a voice analyzer which generates, on the basis of an analysis of voice sample data, a voice profile for entered voice sample data. Moreover, this system includes a voice generator, which converts any text message into synthetic voice sample data on the basis of the voice profile.

Additional features and advantages of the present invention are described in, and will be apparent from, the following Detailed Description of the Invention and the Figures.

### BRIEF DESCRIPTION OF THE FIGURES

FIG. 1 schematically shows a technique for automatically converting text messages into voice messages.

### DETAILED DESCRIPTION OF THE INVENTION

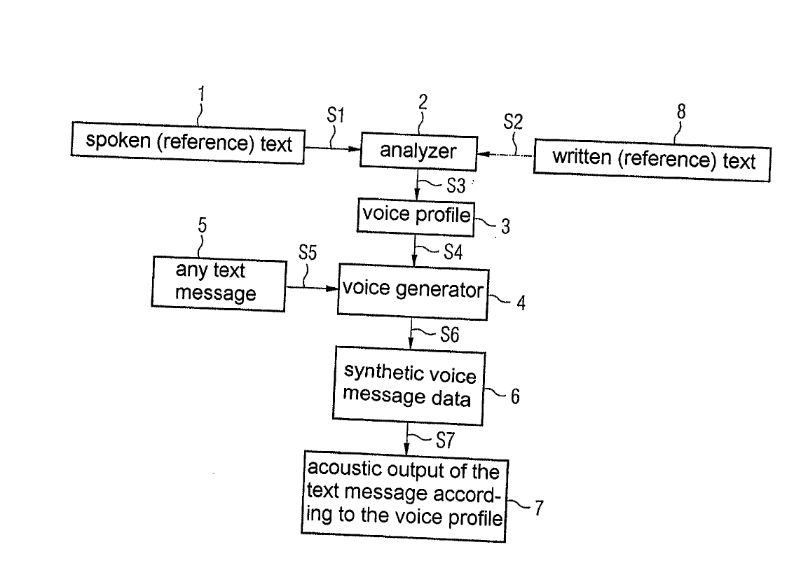

In FIG. 1, a method or a system for automatically converting text messages into voice messages is schematically represented. A text 1, spoken by any person, is analyzed by an analyzer 2 in a step S1. This generally takes place by the acoustic signals being registered in analog form and converted into digital voice files by an A/D converter. With corresponding software, it is possible, in a step S3, for a voice profile 3 of this person to be created on the basis of the performed analysis of the digital voice files. In this case, the spoken text 1 may be any unspecified text or a reference text 8 which, in a step S2, as part of the analysis, is compared with the written form of the reference text 8.

On the basis of the voice profile 3, any desired text message 5 can be translated after that via a voice generator 4 into synthetic voice message data 6 (step S5 and step S6). Subsequently, in a step S7, the text message 5 can be acoustically output according to the created voice profile 3.

It is, thus, possible on the basis of a voice sample 1 of a speaker, using the voice profile 3 obtained as a result, to set a voice generator 4 for a synthetically generated voice in such a way that any texts 5 can be acoustically output with the voice of this speaker. The voice output which is possible as a result, with a voice which is natural and, in particular, familiar, avoids alienation when listening to the output voice. Of course, it is also conceivable for voice samples of various persons, and consequently several voice profiles, to be available to the voice generator. Consequently, a selection of various speakers is possible.

This is of great value, in particular, within multimedia environments; that is, if the linking of a synthetically generated voice to documents of the speaker can be created automatically. The listener can then identify the sender of the message from the voice, which is a way of using modem technology for agreeable communication. It is, moreover, extremely advantageous in this case that the profile generation for the output of the voice can take place automatically from any voice sample within the multimedia environment.

Normally, various documents, such as voice messages (answer machine), e-mails, fax messages, etc., of the same author are managed within a unified message system. In order, for example, to output e-mails within this system on a mobile phone, for instance, the e-mail text is translated according to the present invention into voice. In an advantageous way, a voice message 1 of the same author which has been received in the same system, and the voice profile 3 generated from it, can be used to output the e-mail message with the voice of this author. Given a corresponding voice sample of other persons, such as prominent persons, reproduction of the documents with their voice also would be possible.

In the previously described example, an author thus sends a recipient an e-mail message. As the destination address, the author specifies the telephone number of the recipient. The unified message system used establishes that it is not an e-mail connection but a telephone connection that has been selected as the recipient and therefore converts the entered text into a voice message. For this purpose, a voice profile which previously has been created on the basis of a speech sample of this author is used. Consequently, the voice of the synthetically generated voice output approximates to the natural voice of the author to the extent that the recipient identifies the synthetic voice as the familiar voice of the sending person. The unified message system then arranges for a connection to the telephone of the recipient to be set up and outputs the voice message with the voice of the author.

Although the present invention has been described with reference to specific embodiments, those of skill in the art will recognize that changes may be made thereto without departing from the spirit and scope of the invention as set forth in the hereafter appended claims.

1. A method of automatically converting text messages into voice messages, the method comprising the steps of:
analyzing voice sample data of a user;
creating a voice profile based on the analysis of the voice sample data; and
converting entered text message data into synthetic voice message data, based on the voice profile, wherein the synthetic voice message data approximates the voice of the user and is output.

2. A method of automatically converting text messages into voice messages as claimed in claim 1, wherein the step of creating a voice profile includes comparing reference text data with reference voice sample data, the reference voice sample data being generated by acoustic reproduction of the reference text data by a speaker.

3. A system for converting text messages into voice messages, comprising:
a voice analyzer for generating, based on an analysis of voice sample data of a user, a voice profile for the voice sample data; and
a voice generator for converting any text message into synthetic voice message data based on the voice profile.

4. A system for converting text messages into voice messages as claimed in claim 3, wherein, for generating the voice profile, a written reference text is compared with a form of the written reference text spoken by the user.

5. A system for converting text messages into voice messages as claimed in claim 3, wherein, in multimedia environments, a voice element of the voice messages is automatically analyzed and used for acoustic reproduction of text messages.

6. A mobile telephone, having a system for converting text messages into voice messages, comprising:
a voice analyzer for generating, based on an analysis of voice sample data of a user, a voice profile for the voice sample data; and
a voice generator for converting any text message into synthetic voice message data based on the voice profile, wherein the text messages are documents in a multimedia environment which are acoustically output on the mobile phone in a voice which approximates the voice of the user.
